(19) United States
(12) Patent Application Publication
(10) Pub. No.: US 2014/0032362 A1
(43) Pub. Date: Jan. 30, 2014

(54) METHODS AND APPARATUS FOR READY-TO-BUY CUSTOMIZABLE PROJECT KIT CREATION AND PURCHASE

(71) Applicant: Felix Frayman, Atlantic Beach, FL (US)

(72) Inventor: Felix Frayman, Atlantic Beach, FL (US)

(21) Appl. No.: 13/951,390

(22) Filed: Jul. 25, 2013

Related U.S. Application Data
(60) Provisional application No. 61/675,742, filed on Jul. 25, 2012.
(60) Provisional application No. 61/799,259, filed on Mar. 15, 2013.

(51) Int. Cl. G06Q 30/06

(52) U.S. Cl. CPC G06Q 30/0633
USPC 705/26.8

(57) ABSTRACT

An electronic commerce system has a kit creation module for creating a customizable project kit that is publicly available on-line and a kit buying module for facilitating purchase of a project kit. The system provides automatic substitution of unavailable products or customization of kits by the kit buyers to reflect taste or buyer needs while making sure that selected products fit the intended purpose of the project. The system also may have an assisted products exploration and similar products search capability facilitating specification of customizations available for the project during the kit creation as well as selection of customization options during the kit buying. The system may enable multiple contributors collaborating on a kit, as well as making kit variants. The system may also provide an ability to browse collection of projects, project kits and project kit variants.

### CROSS-REFERENCE TO RELATED APPLICATIONS

This application claims priority to U.S. Provisional Patent Application No. 61/675,742, filed Jul. 25, 2012 and entitled “Methods and Systems for Ready-To-Buy Customizable Project Kit Creation and Purchase,” and to U.S. Provisional Patent Application No. 61/799,259, filed Mar. 15, 2013 and entitled “Methods and Systems for Ready-To-Buy Customizable Project Kit Creation and Purchase,” and each is hereby incorporated by reference herein in its entirety.

### BACKGROUND

1. Field of the Invention

The present invention relates in general to electronic commerce and to project kit commerce more particularly.

2. Background

In the United States, the arts and crafts industry is estimated to generate $30M in annual sales. It includes arts and crafts supplies for hobbyists and professionals. The do-it-yourself and home improvement markets are also important segments of the economy. The passion to explore, make, build and learn can be further enriched by sharing with others, whether it is carpentry, robotics, gardening, or handicrafts. Projects can be found in a variety of places such as internet blogs, project aggregation sites geared towards crafts or hobbies or special interests, social scrapbooking sites, magazines, books, vendor sites, auction and re-sale sites, or web sites of companies selling project plans.

A wide variety of such projects can be undertaken by individuals or groups, e.g., furniture building, renovations, sewing, knitting, scrapbooking, screen printing, digital art, a class, or event planning. Such projects involve creative or transformative activities that can be depicted or represented. For example, a project can be represented by a single photograph of a finished project, which can be self-explanatory to a skilled artisan in the relevant craft. A project can also be represented by a series of photographs, an instructional text, an instructional video, a list of project materials used for the project, or any combination thereof. Inspired by the depiction or representation, an individual may desire to apply their own creativity or aesthetic preference to the project.

### SUMMARY

Novel systems, methods, and articles are disclosed to facilitate the electronic creation and purchase of project kits embodying possibly all the materials, tools, and supplies needed to undertake a project.

A kit creation method allows a vendor-independent user to supply input regarding default product, alternate product, and material specification product information on an optional basis and, in response to received input, retrieves current product information from the relevant vendors via a network-based interface, uses retrieved information to present a product information display to the user, and records project kit information in response to product selection input from the user.

A kit buying method retrieves recorded project kit information based on a selection from the user. Current product information is automatically collected for project materials including price and availability information. That information is used to determine a product selection for each project material and a complete purchasing order is recorded. Online purchasing of a project material in the complete purchasing order may be initiated. Availability information may influence product selection. User preferences stored in a user profile may also influence product selection. A user may be able to add or remove project materials from the active set. A kit buying system is equipped to practice the foregoing method and its variants. A computer storage medium stores program instructions to facilitate the practice of the foregoing method and its variants.

A further embodiment discloses an electronic commerce system offering access to a broad catalog of products, enabling a convenient way for purchasing all desired project materials with a simple transaction, avoiding prolonged searches for the vendors selling correct products in required quantities, transparently handling products unavailability while allowing customization, and providing an option of maintaining functional or structural dependencies between selected products. The electronic commerce system may include a kit creation module for creating a customizable project kit that is publicly available on-line and may include a kit buying module for facilitating purchase of a project kit. Such facilitation may include an option for reducing the complexity to purchase an entire project kit to that approximating the purchase of a single product, even as far as a single click. The system may also provide automatic substitution of unavailable products or customization of kits by a kit buyer to reflect taste or buyer needs while making sure that selected products fit the intended purpose of the project. The system may also include an assisted products exploration and similar products search capabilities facilitating specification of customizations available for the project during the kit creation process as well as selection of customization options during the kit buying process. The system can further enable multiple contributors to collaborate on creation of a kit, as well as creation of one or more kit variants. The system may also provide an ability to browse a collection of projects, project kits and project kit variants. Other system aspects and associated methods are disclosed.

### BRIEF DESCRIPTION OF THE DRAWINGS

FIG. 1 is a high level block diagram of a computing environment according to one embodiment.

FIG. 2 is a high level block diagram illustrating a flow of information between the top level processing modules and repositories according to one embodiment.

FIG. 3 is a flow chart illustrating the operation of a kit creation module according to one embodiment.

FIG. 4 is a flowchart illustrating the operation of a kit buying module according to one embodiment.

FIG. 5 is an illustration of a relation between the information stored with vendor products and manufactured products according to one embodiment.

FIG. 6 is an illustration of construction of a material specification utilizing assisted products exploration according to one embodiment.

FIG. 7 is an illustration of a customization by a buyer utilizing assisted products exploration and state of processing of material selection according to one embodiment.

FIG. 8 is an illustration of kit creation with a simple wiki support allowing multiple kit creators to contribute to the creation of a project kit according to one embodiment.

FIG. 9 is an illustrates a more complex kit creation with wiki support allowing multiple kit creators to contribute to creation and modification of multiple project kit variants according to one embodiment.

FIG. 10 is an illustration of a customization by a buyer and state of processing of project kit materials and constraints according to one embodiment.

FIG. 11 depicts illustrative computer systems useful in the practice of inventive subject matter.

### DETAILED DESCRIPTION

Introductory Concepts

Certain concepts are now generally introduced at the outset of this discussion to facilitate an understanding of the embodiments that are described.

Project

Inventive aspects described herein will be usefully employed to facilitate projects. Such projects involve creative or transformative activities that can be depicted or represented. For example, a project can be represented by a single photograph of a finished project, which can be self-explanatory to a skilled artisan in the relevant craft. A project can also be represented by a series of photographs, an instructional text, an instructional video, a list of project materials used for the project, or any combination thereof.

Project Kit

A project kit can be a structured representation of project related information facilitating implementation of the project. A project kit includes a set of materials that are deemed necessary for implementing a project. A project kit may further include detailed project instructions, photos of the finished project, images of materials, images of implementation steps, images of work in progress, comments, videos, audios and keywords.

Project Instructions

Project instructions represent a description of how to manipulate project materials to implement a project.

Material or Project Material

As described above, each project kit includes a set of materials, where each material is an item that may be used, consumed or transformed in the process of project implementation.

Material Property

A material property can be a characteristic or feature of a material, e.g., size, color, shape, strength, texture. Properties of a project material depend on the material type. For example, if a material is yarn, properties specific to the yarn are color, weight, content, gauge and care. If one material required for a collage project is a fabric, it could be described using the following properties: size, texture, composition, color and pattern.

Material Property Value

A material property value can be a specific value associated with a material property for a given material. For example, for a specific yarn, values of the material properties could be: color is green; weight is 50 g; content is [50% Alpaca/35% Merino Wool/15% Silk]; gauge is US 11; and care is [Hand Wash Cold, Dry Flat].

Tools or Project Tools

Tools represent non-consumable materials that facilitate implementation of the project and can be repeatedly used.

Tool Supplies or Project Tool Supplies

Project materials may include tool supplies that are used in conjunction with a tool and may or may not be consumed in the process.

Product

A product can be a specific embodiment of a project material that may be purchased for project implementation.

Project Material Specification or Material Specification

A material specification can be a set of features that a project material desirably has for the purpose of implementing the project. For example, a material specification provides computer interpretable information sufficient to generate a list of substitute products for a particular project material. A material specification may include search criteria for finding a product satisfying a material specification for a project material. Search criteria for finding products may include textual keywords, product type, identification of important product properties, and associated restrictions on the product properties.

Constraint

A constraint may be a limitation (or specific relation) that may reference one or more materials, material properties, corresponding products, or overall project properties, e.g., the size of the eye of a selected needle must accommodate the size of a selected thread.

Preference

A preference could be a recommendation that guides substitute product selection. For example, if one product material is chosen, then another product material is preferred because it matches or works more smoothly with the chosen material specification. More specifically, a preference could be used to express a taste preference for color matching between materials.

Project Kit Creation Module

In one embodiment, the electronic commerce system includes a kit creation module for: identifying a project; creating from the project a project kit including a list of project materials; associating with each project material on the list at least one of: a default product, a substitute set of products, or a material specification; and storing the project kit in a project kit repository. A kit creation module is used by a kit creator to create a new or modified project kit for a selected project.

A project kit can be a structured representation of project related information facilitating implementation of the project. A project kit includes a set of materials that are deemed necessary for implementing a project. A project kit may further include detailed project instructions, photos of the finished project, images of materials, images of implementation steps, images of work in progress, comments, videos, audios and keywords.

Project instructions represent a description of how to manipulate project materials to implement a project. Project instructions may be broken down into separate steps. Project instructions may be provided in a written form, accompanied by images, video, audio or a combination of different media. Images and videos could depict project materials, intermediate stages of implementation, or illustration of certain procedures.

As described above, each project kit includes a set of materials, where each material is an item that may be used, consumed or transformed in the process of project implementation.

Project materials may include both consumable materials, e.g., items that are used up in the process of implementing the project, and non-consumable materials.

Tools represent non-consumable materials that facilitate implementation of the project and can be repeatedly used.

Some materials could be readily available and may not need to be purchased, e.g., water or tree twigs.

Project materials may include tool supplies that are used in conjunction with a tool and may or may not be consumed in the process. For example, a drill bit or a saw blade is a type of tool supply that is not consumed, except for a normal wear and tear. Glue gun sticks or nail gun nails are examples of tool supplies that are consumed in the process of project implementation. Tool supplies must be compatible with a corresponding tool.

A product can be a specific embodiment of a project material that may be purchased for project implementation.

In one embodiment, the electronic commerce system includes a kit creation module, which allows a kit creator, who is not directly associated with a vendor, to create a project kit, and to access and reference a virtually unlimited catalog of products available from any source. Such a kit creator using the system is independent of a vendor by virtue of not being a paid consultant to, or a part-time, fulltime, or contract employee of, the vendor. In another embodiment, the kit creation module is restricted to products available from specific vendors or brokers that have a dependent relationship with the owner of the kit creation module.

A product may be referenced by a variety of identifiers including, for example, a link to a website. In one embodiment, a product is identified by a single link to the product page on a vendor's website. In another embodiment, a vendor is a broker that provides product information for plurality of vendors and facilitates payment transactions across multiple vendors or performs fulfillment for plurality of vendors. In yet another embodiment, product information for a vendor is provided by a product information aggregator. In one embodiment, product information is collected directly from a website. Product information may also be obtained via an API. When a product is referenced by a link to a website, the embodiment provides capabilities to extract product identifiers from the website or a corresponding API. A product identifier or product ID may be manufacturer specific, vendor or product aggregator specific, or universal, e.g., independent of a specific manufacturer, vendor, product information aggregator or broker.

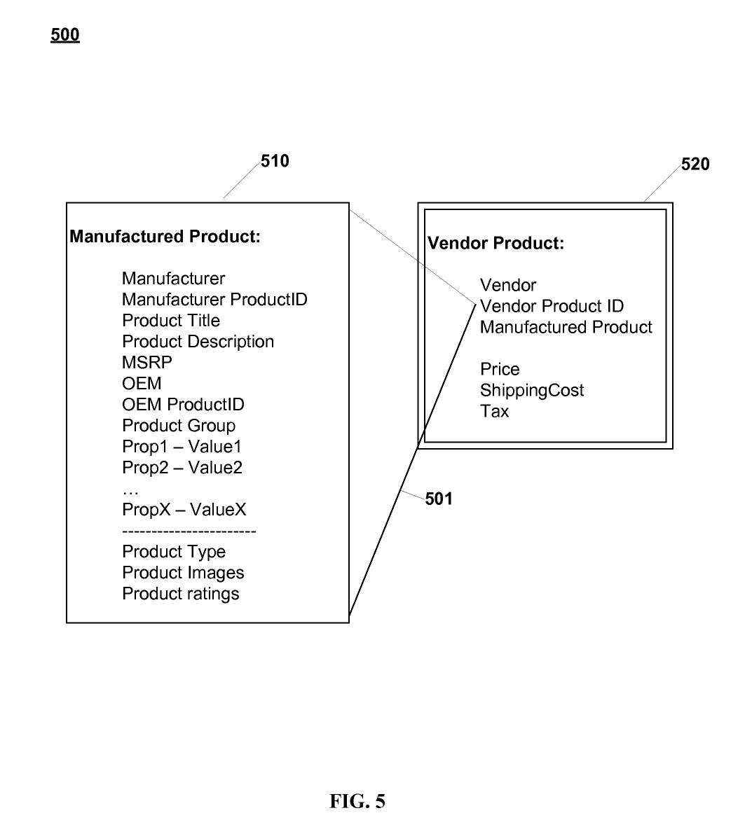

FIG. 5 illustrates relations between the information stored with vendor products and manufactured products according to one embodiment. Manufactured Product record 510 includes product properties that are intrinsic to this particular product as manufactured by a given manufacturer. Vendor product record 520 includes product information for the Manufactured Product 510 that is specific to the vendor such as Price, Shipping, etc. Certain embodiments provide the capability to establish a correspondence between manufacturer product IDs, vendor product IDs and universal product IDs, through the use of keys, indices, correspondence tables, cross reference fields, or the like. Such a correspondence is shown by indicator 501 of FIG. 5 illustrating that Vendor Product ID of 520, in this example, can lead to the proper Manufactured Product record 510. In one embodiment, the system provides capability for establishing a correspondence between different country-specific product IDs via the same or equivalent mechanisms.

In one embodiment, the electronic commerce system provides a kit creation module that allows a kit creator to select a project of interest and create a new list of project materials needed for the project if the project does not contain a description of the materials needed.

In addition, the system may generate a list of project materials using information from the project using known techniques of natural language understanding for extracting information from text. This process is facilitated by relatively narrow domains of discourse that limits potential interpretations of the natural language used in the project description. In addition, extraction of project materials information may be facilitated by analyzing text formatting used in the project description. Thus, the system can facilitate the creation of a project kit by extracting information from the project, including a list of project materials for implementing the project, as well as the properties of the project materials, e.g., a materials specification for one or more project materials.

Each project material may be designated as either a required material or an optional material. An optional material represents a project add-on feature. The project could still be deemed as successfully implemented without use of this optional material. Similarly, an optional tool may represent a tool that makes project implementation more efficient by saving time or making implementation easier.

In one embodiment, for each project material specified for a project kit, the kit creation module facilitates identification of a default product, a substitute set of products, or a material specification by the kit creator. In another embodiment, either the kit creator or the system provides a default product for each material on the materials list. This allows a kit buyer to simply and easily purchase all the materials at once if default materials are available at the time of purchase. The system may automatically update product information in real-time for each default product in a list of project materials when a kit buyer initiates the kit buying process for a particular project kit. This is merely one example of the benefits of real-time, updated product information that may be extremely helpful to the kit buyer in making purchasing decisions regarding the project kit.

In case a default product is unavailable at the time of purchase, a set of substitute products may be used to select an available substitute product for that project material. In one embodiment, an automatically generated set of substitute products is used to select an available substitute product for the project material. In this way, a system can automatically ensure that all products needed for a project are available from one or more vendors and can be purchased in a single transaction.

Each default product or product listed in a substitute set of products may have associated order quantity necessary to meet the material quantity needed. Each product order quantity may have an associated unit of measure.

In addition to or instead of a substitute set of products, a kit creator may provide a material specification as a way to generate a set of substitute products that will work in the project kit. In one embodiment, a substitute set of products and a material specification are used to specify a set of products that are equally suitable for the project purposes, and the selection is up to the kit buyer's personal taste or needs.

A material specification can be a set of features that a project material desirably has for the purpose of implementing the project. For example, a material specification provides computer interpretable information sufficient to generate a list of substitute products for a particular project material. A material specification may include search criteria for finding a product satisfying a material specification for a project material. Search criteria for finding products may include textual keywords, product type, identification of important product properties, and associated restrictions on the product properties.

A material property can be a characteristic or feature of a material, e.g., size, color, shape, strength, texture. Properties of a project material depend on the material type. For example, if a material is yarn, properties specific to the yarn are color, weight, content, gauge and care. If one material required for a collage project is a fabric, it could be described using the following properties: size, texture, composition, color and pattern.

A material property value can be a specific value associated with a material property for a given material. For example, for a specific yarn, values of the material properties could be: color is green; weight is 50 g; content is [50% Alpaca/35% Merino Wool/15% Silk]; gauge is US 11; and care is [Hand Wash Cold, Dry Flat].

A property value may have an associated unit of measure. A property value could also be represented by a set of values or as a set of pairs of values. Other embodiments may provide additional ways to represent a property value.

Restrictions on the material property values could be expressed as a single range or a set of ranges, a single value selection, a multi-selection, a single de-selection or a multiple de-selections.

A material specification may identify at least one product available from at least one vendor.

A material specification or a substitute set of products may also include a preferred ordering so that if the default product is no longer available at the time of purchase, the system may provide the next available product. A set may be ordered according to a variety of criteria. In one embodiment, a substitute set of products may be provided as an ordered list with a position on the list implying an order of preference, first to last. In another embodiment, ordering could be specified by rank ordering of material properties, property values and other ordering features, e.g. sort by price then by preferred vendors. In yet another embodiment, products may be ordered to maximize generation of commission fees if a kit creator negotiated different commission fees for different manufacturers or vendors.

The kit creation module may also facilitate adding constraints and preferences between or among different materials in the project kit as needed.

A constraint may be a limitation (or specific relation) that may reference one or more materials, material properties, corresponding products, or overall project properties, e.g., the size of the eye of a selected needle must accommodate the size of a selected thread.

The kit creation module may also facilitate introduction of compatibility constraints between tools and corresponding tool supplies. For example, if a specific glue gun is chosen, then glue sticks of a certain size are needed.

In another embodiment, the kit creation module automatically associates a constraint with every material specification of the following form: “Quantity of material needed” less or equal “product material quantity”* “product quantity to be ordered.” In case “Quantity of material needed” is not specified, it is assumed that it is equal to the “product material quantity” of the default product multiplied by its “product material quantity.” The kit creation module can automatically determine the “quantity to be ordered” for the substitute products based on such a constraint and information about the amount of material in the product package, taking into account units of measure.

A preference could be a recommendation that guides substitute product selection. For example, if one product material is chosen, then another product material is preferred because it matches or works more smoothly with the chosen material specification. More specifically, a preference could be used to express a taste preference for color matching between materials.

The related kit buying module facilitates identification of vendors selling products by the kit creator. The kit buying module obtains vendors product information including prices and shipping and handling charges. The kit creator may preview the kit buying module and modify the project kit as needed or desired. Additionally, a kit creator may create project instructions if needed. To make a project kit available to the buyers, the kit creation module saves a project kit in a project kit repository and facilitates creation of a link between the project and the associated project kit. And, finally, the kit creation module monitors and notifies the kit creator when a default product or all substitute product options become unavailable.

In another embodiment, the kit creation module is further capable of enabling the kit creator to associate images, detailed instructions, comments, videos, audios and keywords, with the project kit.

The kit creation module may also enable a kit creator to associate a design with certain materials, allowing a kit buyer to create the material. In one embodiment, the kit creator may associate a 3-D print design with a material, allowing a kit buyer to create the material using a 3-D printing process. In another embodiment, a kit creator may create a custom fabric pattern design that incorporates a photograph that is substitutable by a buyer who may order the custom-made fabric.

Project Kit Buying Module

The electronic commerce system provides a kit buying module for creating a complete purchasing order for a project kit stored in the project kit repository. “Module” here does not denote any particular form of software or hardware packaging or storage but rather suggests a unifying purpose—kit buying—toward which possibly disparate, widespread, and loosely associated computing resources and processes can contribute as orchestrated. Further, as a “module” may at times be considered chiefly in terms of its software resources that direct the execution of processing circuitry, one of skill can appreciate the discussion of a module as both an actively executing data processing entity as well as a dormant entity in computer readable storage.

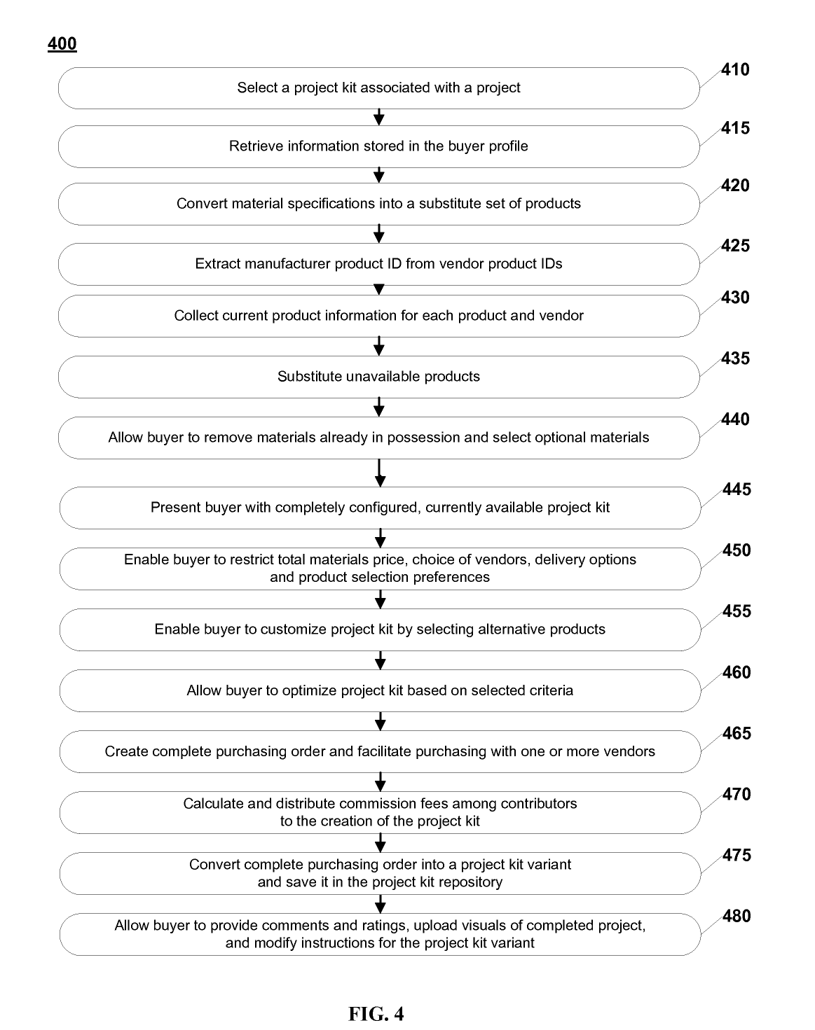

FIG. 4 illustrates one example of the operation of a kit buying module. A person skilled in the art may alter sequence and number of steps from the one illustrated. Thus, other embodiments may include additional steps or substitute certain steps deviating from the steps presented. The kit creation module facilitates selection by a kit buyer of a project kit associated with a project 410. A kit buyer may find a link to the project kit embedded in a web site containing project information or a reference link to the project information. Such web sites may include a blog, an auction web site, a vendor aggregator web site, a social bookmarking web site, a photo sharing website, a class web site, a publisher's website or a vendor's website. In one embodiment, such link could be manually embedded in a blog web site, a publisher web site or a vendor web site. In another embodiment, a link is automatically inserted and enabled via an aggregation web site API. In yet another embodiment, a link to a project kit could be provided via a browser bookmarklet, a browser add-on, an extension or similar technology when a buyer is on a web page containing project information. In yet another embodiment, a link to a project kit is made available via interactive TV. In case a project kit is not available for a project, a request to create a kit could be posted. A link to a project kit may also be displayed in a print publication such as magazine, a book or a flier in a human readable form or computer readable form. In one embodiment, a QR code may be used to identify a project kit in a publication. A kit buying module can also enable a kit buyer to select a project kit directly from the project kit repository. A project kit repository is available to the public online and can be searched by project name, keywords, materials or project parameters to find interesting projects to try. As new project kits are stored in the project kit repository, the repository becomes populated with an array of project kits that people can browse and use to generate new ideas for project kits or to find project kits to make for themselves, as gifts, or for sale. A project kit that has been created can then be used by others to help them purchase kits that have been designed to work and may optionally include ratings or other comments by users.

In one embodiment, a kit buyer is given an option to create a login for the kit buying module, allowing retrieval, alterations and storage of kit buyer preferences. A kit buyer's profile may include preferences for one or more of the following: product types, pricing, preferred vendors, preferred vendor stores and delivery preferences, preferred manufacturers, minimum vendor or product customer feedback ratings, allowance for non-OEM products, etc. Additionally, a kit buyer's profile may store membership in vendor affinity programs, tools already in possession, shipping addresses, vendor login credentials, and payment details. In one embodiment, a kit buyer's profile may additionally store information for third party administrators of the login and payment details.

A kit buying module may retrieve information stored in a buyer profile for an authenticated buyer 415. The next steps may include converting material specifications into a substitute set of products 420, extracting manufacturer product IDs from vendor product IDs 425 and collecting current product information for each product and vendor 430.

For default products that may be currently unavailable at the time of purchase, the kit buying module can perform an automatic substitution for any unavailable products 435 taking into account product availability, constraints, as well as kit creator and buyer preferences.

In one embodiment, kit buyer preferences override kit creator preferences when they are in conflict. In another embodiment, when preferences are in conflict, a kit buyer may choose what preference will take precedence.

A kit buyer may designate certain materials for local shopping. The system can prepare a detailed shopping list for these materials that could be printed, sent via email, or text messaging, delivered to a mobile shopping list application or made available on a website accessible via a mobile device. The shopping list of materials may provide aisle information for location of an item in a vendor's store.

A kit buyer is allowed to remove materials already in possession 440 of the kit buyer or may choose to select optional materials to enhance the project. Thereafter, a kit buyer is presented with a fully configured, currently available project kit 445 that is ready to order.

In one embodiment, in case a default product and all substitute set products are currently unavailable, the kit buying module can automatically create an implicit material specification based on the relative importance of material properties and values, allowing a kit buyer to find currently available product substitutions that will work instead. In case there are no currently available products satisfying an existing material specification as well, a kit buying module automatically relaxes this material specification. Derivation of importance of material properties and property values utilizes machine learning algorithms applied to the analysis of prior product substitution selection patterns by kit buyers that customized project kits.

In one embodiment, in case there are no available products satisfying all imposed constraints, a kit buyer is notified by the system of this situation. In another embodiment, in case there are no available products satisfying all imposed constraints, a kit buyer is advised on ways to relax constraints imposed by the kit buyer. For example, a buyer may be notified that: (a) a certain product may become available shortly, (b) increasing a total price for the project kit by a certain amount may resolve the conflict, or (c) revisions of the allowed vendors or allowing non-OEM products may result in product availability.

To allow further customization of the project kit, a kit buying module enables a kit buyer to restrict total materials price, choice of vendors, delivery options, and product selection preferences 450. In one embodiment, a kit buyer may choose to impose a range restriction on the price of a single project material, a set of project materials or all project materials. In addition, a kit buyer may indicate if the price takes into account all additional fees that may include taxes as well as shipping and handling fees. The kit buying module automatically changes product selections for project materials to satisfy such additional constraints.

Additionally, the kit buying module provides direct manipulation of the product materials by enabling a buyer to customize a project kit by selecting alternative products 455. The kit buying module allows a buyer to manually select from a currently available substitute set of products for each product material when substitution sets are present. Such substitutions could be based on taste or needs of the kit buyer. In one embodiment, a kit buyer may modify the notion of product availability from currently available to available within a certain time frame if a buyer has the flexibility of waiting for delivery. In another embodiment, the kit buying module allows a kit buyer to find and substitute a product that may not conform to the kit creator's project material specifications or substitute set of materials.

Furthermore, the kit buying module allows a buyer to optimize project kit based on selected criteria 460. For example, a kit buyer may ask for a kit with: (a) the lowest total price including shipping, (b) a configuration for fastest delivery, or (c) the smallest number of vendors contributing.

Upon completion of customizations, the kit buying module creates a complete purchasing order and facilitates purchasing with one or more vendors 465 or brokers. In one embodiment, the kit buying module facilitates purchase of selected products by creating a kit order for each vendor or broker while redirecting a buyer to complete the transaction on the websites of the vendors and brokers. In another embodiment, the system utilizes a login credentials repository where a user stores his information to facilitate login to the sites of vendors and brokers. In another embodiment, the system may utilize a checkout and payment repository where the user stores his information to facilitate completion of the payment on the sites of vendors and brokers. In yet another embodiment, the kit buying module completes payment transaction and places orders with vendors and brokers on behalf of the buyer, transparently to the buyer. In another embodiment, the kit buying module utilizes information stored in the buyer profile or may utilize third party login and checkout payment repositories. If a vendor allows local pickup, the system may communicate selected items information to a local vendor store where items could be pre-packaged and await the kit buyer for a pickup.

Upon completion of the order placement, the kit buying module calculates and distributes commission fees among contributors to the creation of the project kit 470 based on the information contained in the project kits.

In one embodiment, the system enables converting a fully configured kit purchase order into a project kit variant and saving it in the project kit repository 475, while establishing links with the project and the original project kit.

After the purchase, a kit buyer may provide comments and ratings, upload visuals of the completed project, and modify instructions for the project kit variant 480.

The kit buying module enables a kit buyer to order more than one of the same materials kit while properly ordering multiple consumable materials and ordering just one set of tools. The kit buying module also takes into account materials needed and leftovers from a single product package, thus avoiding ordering of excess materials.

An embodiment may allow a kit buyer to configure several unrelated kits together properly taking into account overlap in materials and avoiding duplicate or unnecessary ordering of materials.

Certain products may be sold in a bundle. An embodiment may enable handling of bundles where a bundle may satisfy more than one material in a project kit. For example, a project kit may require a drill tool and a drill bit tool supply. A vendor may bundle together a drill with a set of drill bits in which case selection of such bundle would simultaneously satisfy both tool and tool supply material requirements.

In another embodiment, the system may be used for ordering supplies for events or parties requiring a large number of the same kits being purchased. In such situations more than one person could be involved in the implementation of the project. For example, a children's party is planned for 30 children where each child would be implementing a project. A project kit for the party contains a specially curved blade scissors as a tool. The kit buying module allows specifying for each tool, a ratio of project implementers per tool, allowing tool sharing and avoiding the unnecessary expense of ordering the same number of tools as the number of project kits.

In one embodiment, the kit buying module enables updating an image of the final product based on the product selections for the project kit.

Assisted Products Exploration

An embodiment may enable assisted products exploration, which makes it easier for kit enthusiasts to ensure that they find and select materials that will work for the intended project while accommodating different requirements, tastes, and preferences of kit creators and kit buyers.

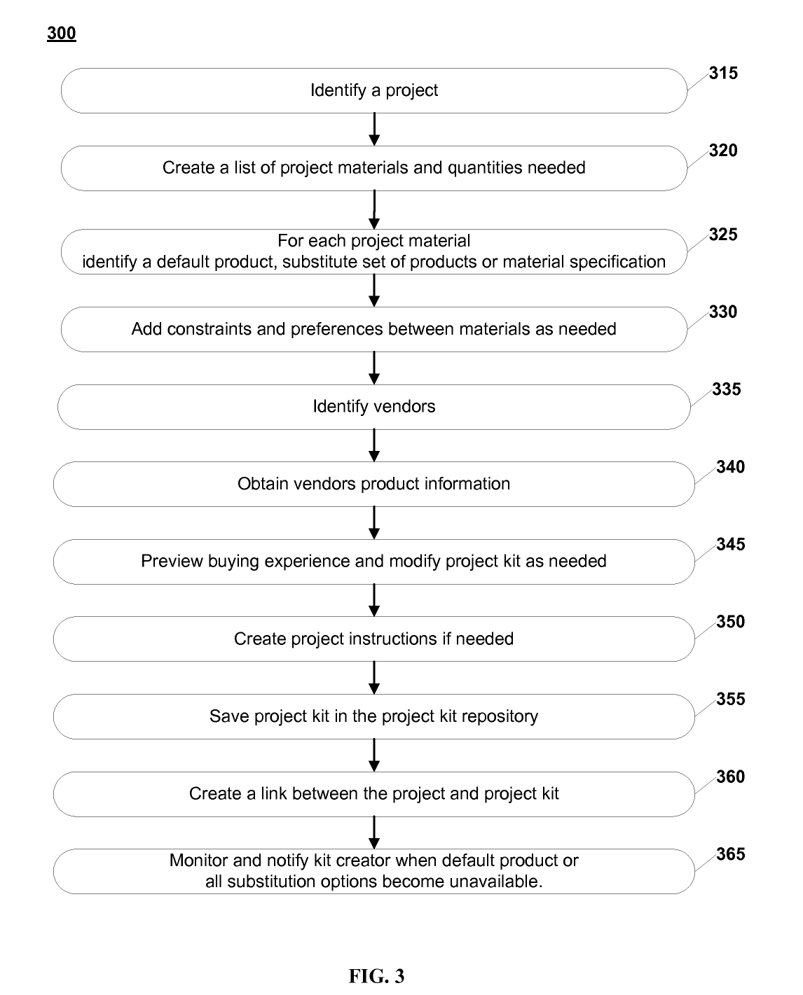

Step 325 in FIG. 3 references creation of a material specification for a material listed a project kit. As discussed above, a material specification describes the features of a material for a particular project kit, and may be used to guide a kit buyer in an assisted products exploration.

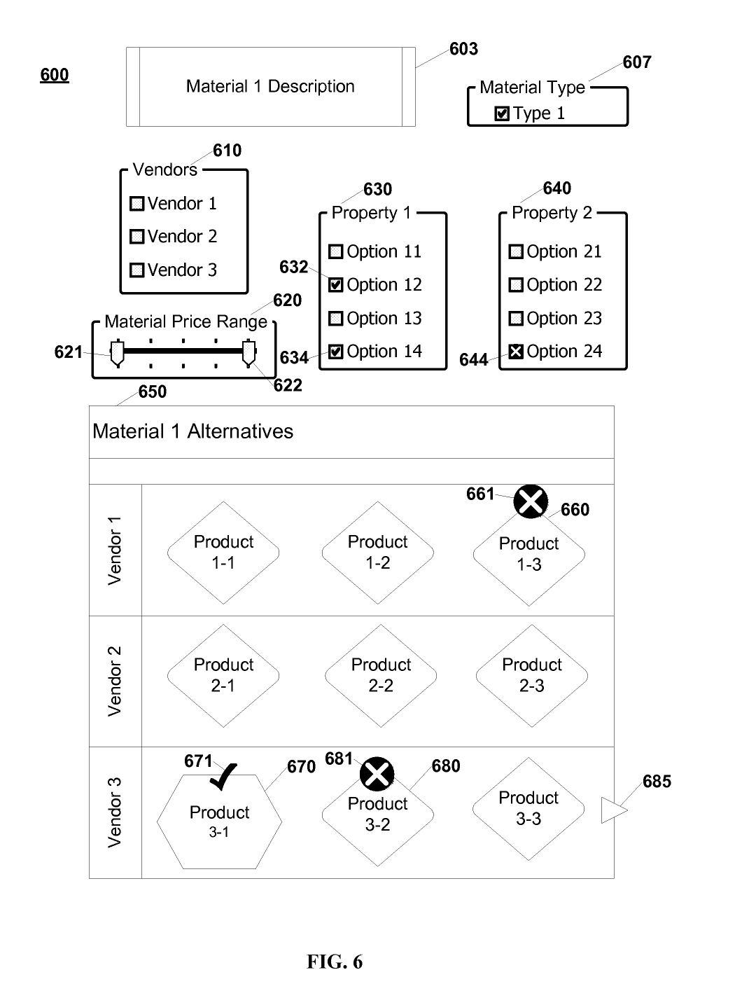

For example, FIG. 6 illustrates a material specification construction utilizing assisted products exploration according to one embodiment. FIG. 6 depicts illustrative graphical user interface (GUI) elements that may be employed by a kit creation module to communicate with a kit creator including text box 603, checkbox groups 607, 610, 630, and 640, slider control 620, and graphics window 650. It is well understood that such GUI elements and the hardware-resident program code that actively implements them are one popular mechanism used to allow a user to supply inputs as desired to the computing process as well as being used by the computing process to prompt for, present, or display information to the user. A kit creator enters descriptive information for the Material 1 into text box 603 which may be used to identify it, along with an identification of the Material Type in checkbox group 607. In some embodiments, text box 603 may be pre-populated with descriptive text provided by the system in response to an earlier selection by the user identifying the project material from, for example, a displayed list of known project materials. Products for this material are found at three vendors which the kit creation module populates into checkbox group 610. The three vendors are found as a result of querying caches, data stores, or making real-time queries to vendors and/or their equivalents, such as an agent or representative, using network-based interfaces such as web servers or API's, for example. Materials of this type are described by two properties Property1 630 and Property2 640 with corresponding property values shown by the kit creation module.

A kit creator identified that products with Property2 640 value of Option24 are not suitable for this material for the purposes of this project by exercising input options available in the graphical user interface, perhaps using a mouse or touchscreen. The kit creation module received the user input which triggered removal of Product1-3 660, indicated to the user by the addition of the X-out graphic element 661, since Product1-3 had Property2 value of Option24 (assumed for this discussion). Block 650 represents the status of a material specification process as maintained in computer memory and as possibly presented to the user in the graphic fashion of Block 650. A kit creator also identified that products with Property1 630 values of Option12 and Option14 are suitable for this material for the purposes of this project, again by exercising input options of the GUI. In response to the user input the kit creation module updated checkbox group 630 to include checkmark graphic elements 632 and 634. Product3-1 670 is the default product specified by the kit creator by exercising the kit creation module GUI resulting in the display of checkmark graphic 671 reflecting a new status of the material specification process being maintained in computer storage by relevant portions of the kit creation module. Product3-2 680 was removed by the kit creator as unsuitable, again by exercising the GUI. Arrow 685 is presented by the kit creation module to indicate that there are more products available from Vendor3.

Step 455 in FIG. 4 illustrates customization of a project kit by a kit buyer. A kit buyer may perform customization of material selection relying on a material specification created by the kit creator. In the following illustration, a kit buyer starts with a material specification for the Material 1 603 from FIG. 6.

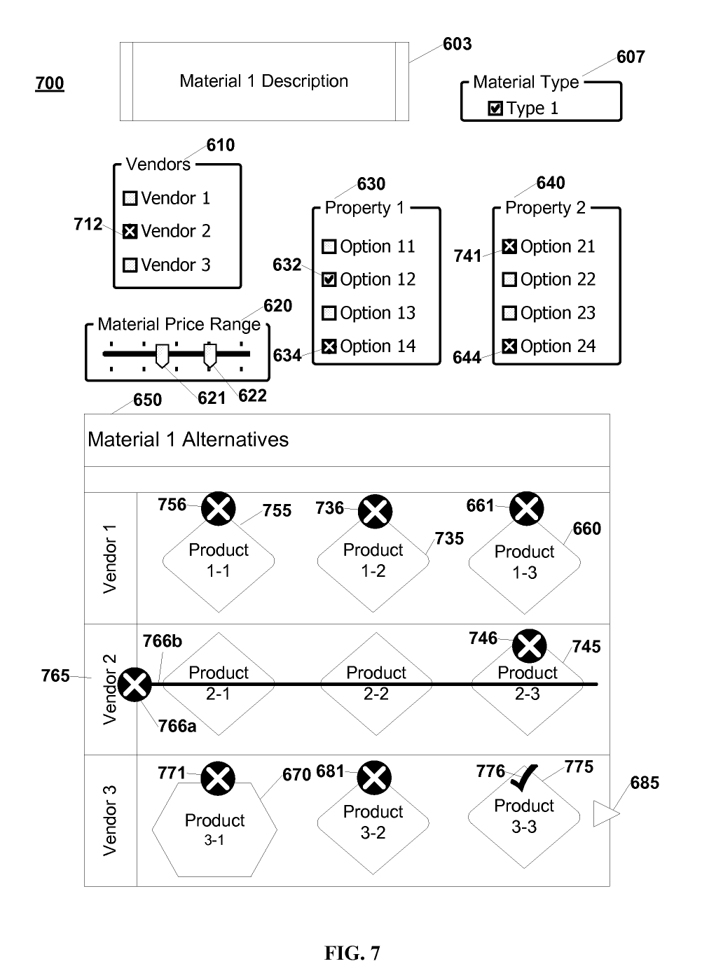

FIG. 7 illustrates a customization by a kit buyer utilizing assisted products exploration and the state of processing of material selection according to one embodiment. Notably, that while discussed in terms of kit buying, the interface and processing described here can be advantageously utilized during the kit creation process as described, for example, in reference to FIG. 3. FIG. 7 depicts illustrative graphical user interface (GUI) elements that may be employed by a kit purchasing module to communicate with a kit buyer performing customization of a project kit including text box 603, checkbox groups 607, 610, 630, and 640, slider control 620, and graphics window 650 (seen previously in relation to FIG. 6). FIG. 7 illustrates by the appearance of X-out graphic element 712 that a kit buyer de-selected Vendor 2 from the list of vendors 610 by exercising input options available in the graphical user interface, perhaps a mouse or touchscreen. The kit buying module received the user input which triggered an update to the status of the current material selection process as maintained in computer memory to record removal of all corresponding products available from this vendor 765. The kit buying module reflected this update in status by adding the strikeout bar consisting of graphical elements 766a and 766b to graphics window 650.

The system verifies that all imposed constraints are not violated. The system de-selects products that are incompatible with current selections. When a default product for a material has been removed due to unavailability or incompatibility, the system may pick a substitute product or allow a kit buyer to make an alternative selection.

As an example of FIG. 7, a kit buyer restricted the price range for the subject material by using GUI slider control 620: providing inputs to set a low price with slide indicator 621 and set a high price with slide indicator 622. As the inputs were interpreted and recorded as changes to the price range in the stored material selection status, and as the locations of graphical elements 621 and 622 were updated, a consistency checking function of the kit buying module detected that the price of Product1-1 755 now fell outside of the recently updated material price range (presumed for this discussion) and Product1-1 had its stored status changed and the kit buying module added X-out graphical element 756 to graphics window 650. The kit buyer decided that products that have Property1 630 value of Option14 will not work to satisfy the buyer's taste and informed the kit buying module by exercising GUI input options. The kit buying module received the input, updated checkbox group 630 with X-out graphical element 634, and indicated removal of Product1-2 735 by adding X-out graphical element 736 to graphics window 650 since Product1-2 had Property1 value of Option14 (presumed for this discussion). The kit buyer then decided that products that have Property2 640 value of Option21 would not satisfy buyer's needs and exercised input options of the kit buying module GUI. This again triggered interpretation of the received user input, updating the recorded status of the current material selection process including, for example, selection parameter status and product status, consistency checking to ensure current product status reflects current selection parameters, and the presentation of changed status to the user here illustrated by updating graphical elements in a GUI display. Processing the input indicating an exclusion of the Property2 640 value of Option21 results in removal of Product2-3 745 presumably having that property, and an update of display 700 with X-out graphic elements 741 and 746. Product3-1 670 is presumed for this discussion to be the default product specified by the kit creator, but it was removed by an availability checking function of the kit buying module because it was presumably not available for purchase when the kit buyer was in the process of customizing the project kit. X-out graphical element 771 was added to graphics window 650 to reflect this fact. Product3-3 is a product selected by the kit buyer as the current choice for the Material 1 and that status is reflected by the placement of checkmark graphical element 776 into graphics window 650 by the kit buying module.

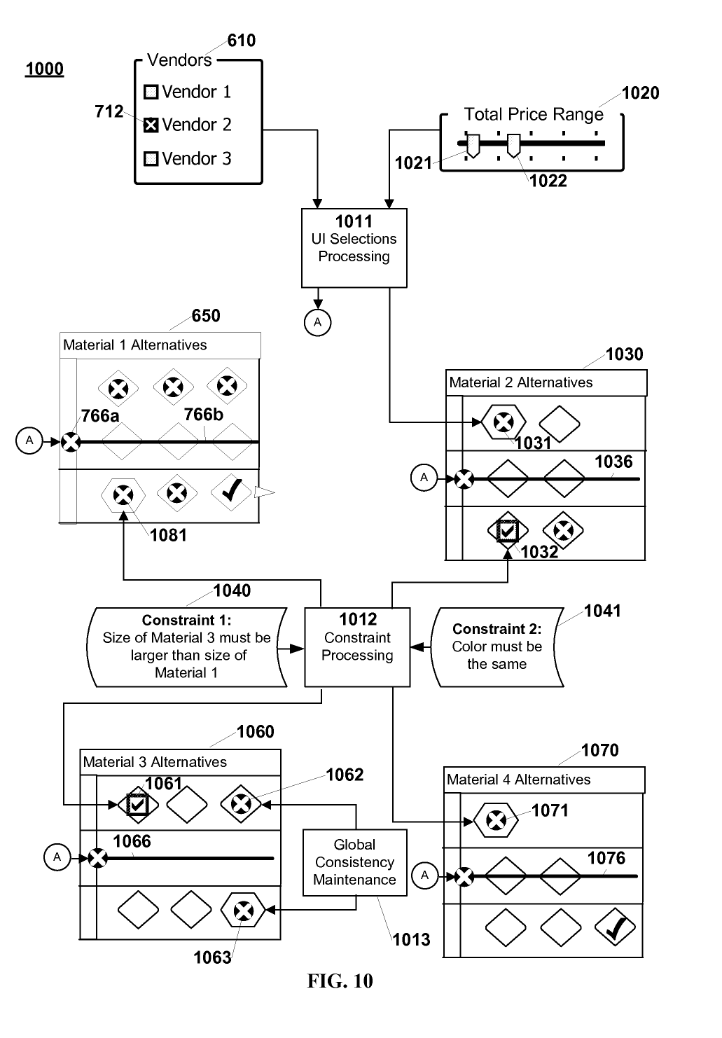

FIG. 10 is an illustration of a customization by a buyer and the state of processing of project kit materials and constraints according to one embodiment.

Similar Products Search

Assisted products exploration is a top-down approach to exploring suitable substitute products. Similar products searches may accomplish the same goals as the assisted products exploration, but it could be characterized as a bottoms-up approach. A user starts with a product and is interested in finding similar products. The system determines product type of the original product and a set of properties and property values for this product. Then the system allows a user to identify which properties are important and which ones are not, also it allows specifying which property values must be maintained and which ones may be relaxed. For example, a user may start with a specific package of nails which are 1 inch length, black color, galvanized, and manufactured by Hillman. A user may specify for their needs a similar nail by any manufacturer is fine, so long as it is: 1 to 1.25 inches in length, black in color, and galvanization is optional.

Guided Products Selection

For certain material types, the system provides a guided products selection mode for finding an appropriate product as another way to select or narrow down product selections. In this mode of operation the system asks questions of the user and creates restrictions on the product properties based on the answers provided, thus narrowing down a set of products that would satisfy user needs.

Project Kit Wiki and Social Interaction Features

A wiki software allows users to create and collaboratively edit content on the internet.

An embodiment may provide several features fostering a wiki-style collaboration between kit creators and kit buyers working on project kits, in some cases even blurring the distinction between the two roles.

FIG. 4 step 475 illustrates an ability to convert a complete purchase order into a project kit variant, saving it in the project kit repository. This enables kit buyers either to order one of the existing kit variants or use one of them as a starting point for customization.

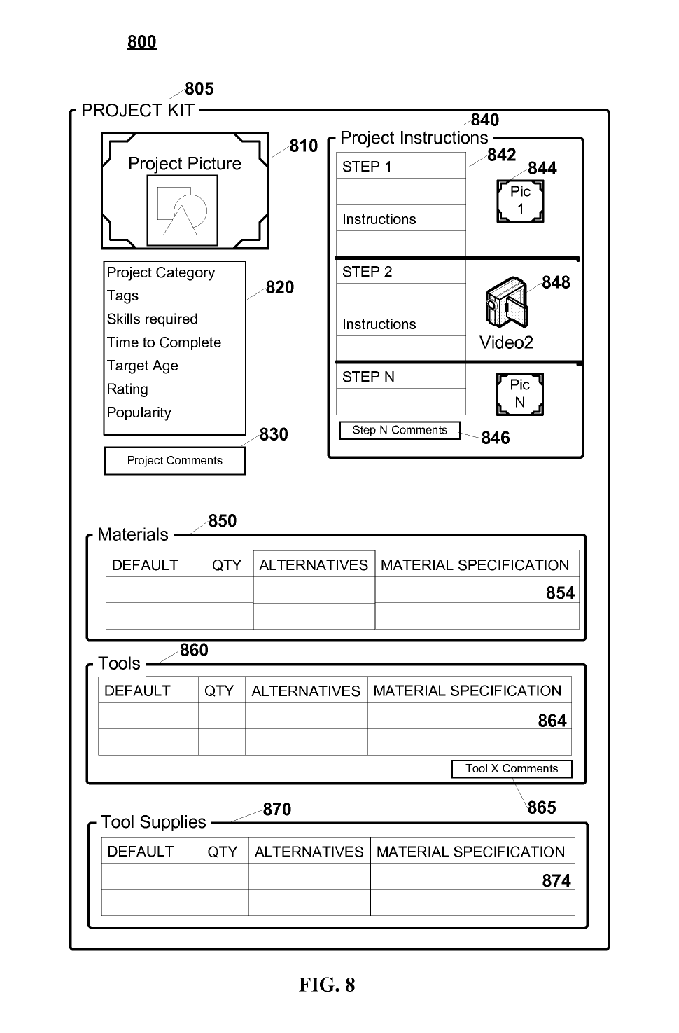

FIG. 8 depicts a simple operation for a kit creation with a simple wiki support allowing multiple kit creators to contribute to creation of a project kit according to one embodiment. While discussed herein terms of multiple kit creators one of skill will recognize the applicability of the described data storage regardless of the number of creators. One of skill may also appreciate the correspondence that could be made between the storage areas depicted in FIG. 8 and GUI elements that could be used to interface the stored data with a user. For example, materials storage area 850 as illustrated could correspond to a GUI graphics window element that includes title text box elements showing the field names “DEFAULT”, “QTY”, “ALTERNATIVES”, and “MATERIAL SPECIFICATION”, appearing over two rows of four user-alterable text boxes, where each row corresponds to a tuple of data and the user-alterable text boxes in a row correspond to the default product, quantity, alternative product, and material specification information of the tuple. Each such user-alterable text box can be used to communicate stored field contents from the system to the user and/or allow the user to communicate desired field content input to the system. Appreciation of such possible correspondence between stored data elements and GUI elements is not limited to FIG. 8.

Project kit 805 illustrates one possible embodiment for a project kit entry or instance as might be stored in a project kit repository. Project kit 805 comprises storage areas for a project picture 810, project meta-data 820, project comments 830, project instructions 840, materials 850, tools 860, and tool supplies 870. The creation and population of project kit 805 is now discussed by a usage case example to further illuminate inventive subject matter disclosed herein. In this usage case, a computer system hosts a project kit repository, a kit creation module, and a Web server. User interface for the kit creation module is principally conducted using the Web server which kit creators access using a web browser or app(lication) on their computer or mobile device. In one embodiment, a first project kit creator may find an image or a photograph on the Internet and create a project and the initial project kit 805 instance using the kit creation website to provide user input to the kit creation module. The project kit creator may post this picture (then stored in 810) along with a request for help with implementation of the project for an artifact similar to the one depicted in the image. After discovering the project kit 805, a second project kit creator posts project instructions that are stored in 840. A third project kit creator joins in, filling in project meta information then stored in 820, project comments then stored in 830, and creating a list of consumable project materials with product defaults selected, then stored in 850. A fourth project kit creator follows up by providing information for project tools then stored by the kit creation module in 860, and information for tool supplies then stored in 870. A fifth project kit creator provides additional instructions information in the form of a picture then stored at 844 for the Step1 of the instructions, adding a video then stored at 848 for Step2, and providing comment text on StepN then stored at 846. The fifth project kit creator makes project materials customizable by providing materials specification then stored at 854, while a sixth project kit creator fills in materials specifications for tools then stored at 864, and for tool supplies then stored at 874, while providing comment text on one of the tools, Tool X, then stored at 865.

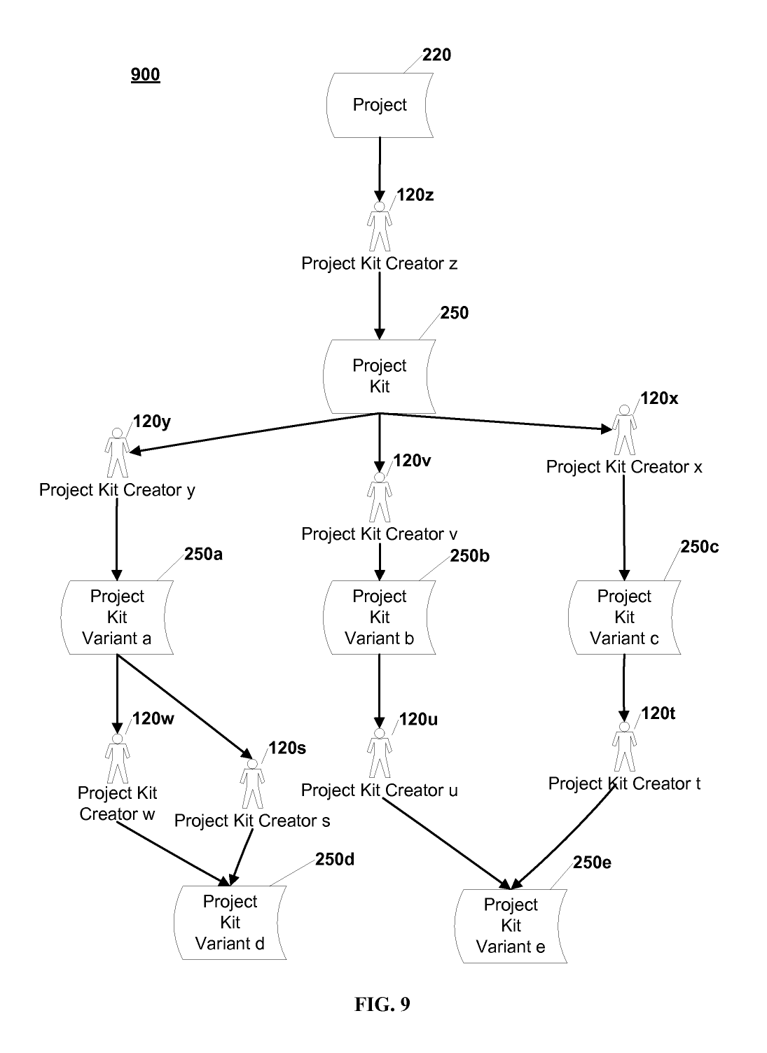

FIG. 9 is an illustration of a more complex operation for a kit creation with wiki support allowing multiple kit creators to contribute to creation and modification of multiple project kit variants according to one embodiment. The Project Kit Creator 120z creates a Project Kit 250 for the Project 220. Project Kit Creator 120y may modify the original Project Kit 250, creating a Project Kit Variant 250a, while Project Kit Creator 120v creates a Project Kit Variant 250b and Project Kit Creator 120x creates a Project Kit Variant 250c. In one embodiment, such project kit variants may be selecting different substitute products or may have completely altered one or more materials from what was specified in the Project Kit 250. Project Kit Creators 120w and 120s used Project Kit Variant 250a as a starting point and collaboratively created a Project Kit Variant 250d. Project Kit Creators 120u and 120t collaborated on creating Project Kit Variant 250e borrowing pieces from the Project Kit Variant 250b and 250c.

In one embodiment, the system provides capabilities to maintain dependencies and propagate changes between kit variants using software version control techniques.

In another embodiment, a kit creator may also provide his own photo of his version of the project as well as modified detailed instructions on how to implement the project from the list of project materials for his kit variant.

The system facilitates users to automatically or manually post project kit related activities on social networks. The system may also provide a mechanism to purchase certain products at a volume discount by bundling together orders from several kit buyers.

The system also provides facilities for creating a marketplace for project implementations where a kit buyer may subcontract project implementation to another party. A kit buyer may purchase all the materials requesting a delivery to the project implementer while paying the implementer for the work. Alternatively, a kit buyer may pay a project implementer for the supplies and the work in a single transaction, leaving it to the implementer to order project materials. Certain parts of a project may be particularly time consuming or require specialized skills. The system enables a kit creator or kit buyer to subcontract just a portion of a project instead of a complete project implementation. In one implementation, the system provides an auction facility to complete project implementation subcontracting.

### ADDITIONAL DETAILED DISCUSSION OF THE FIGURES

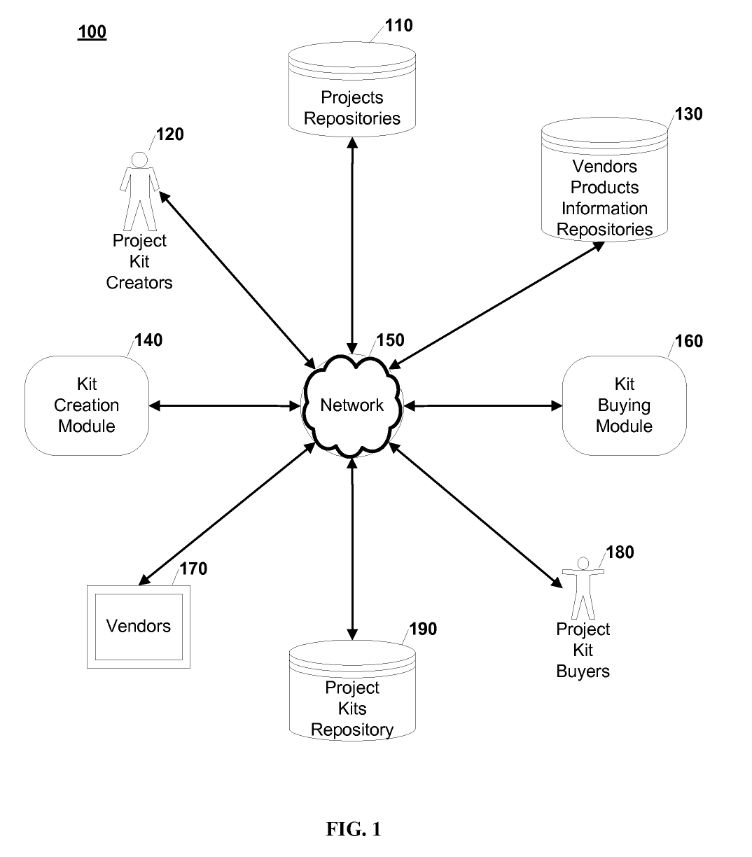

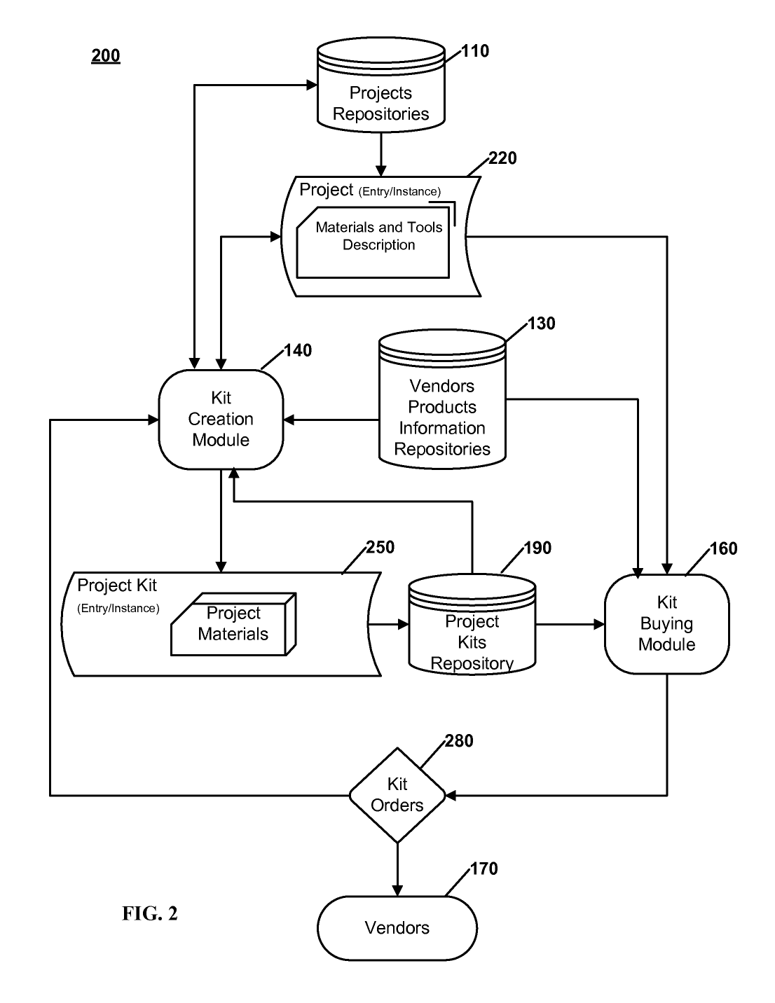

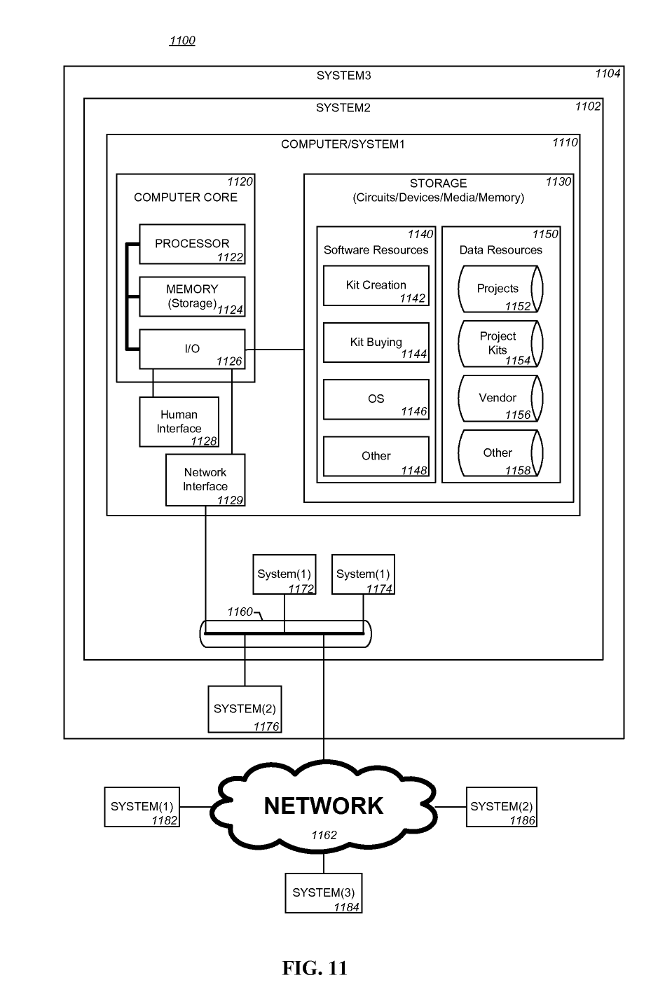

FIG. 1 illustrates a high level block diagram of a computing environment according to one embodiment of this invention. In FIG. 1, a Computer Network 150 connects three different types of actors, e.g., Project Kit Creators 120, Project Kit Buyers 180, and Vendors 170, with various repositories or modules, e.g., Project Repositories 110, Vendor Products Information Repositories 130, Kit Creation Module 140, Kit Buying Module 160, and Project Kits Repository 190. FIG. 1 is, of course, abstracted to facilitate an understanding of the invention and one of skill in the art will appreciate and understand the implementation of a computing environment such as illustrated in FIG. 1 in a computer system such as those later illustrated and described in reference to FIG. 11. As one example, the Project Kit Creators 120, Project Kit buyers 180, and Vendors 170 of FIG. 1 might each be viewed as corresponding to a computer they use to access a project kit system such as computer 1110 of FIG. 11. Similarly, FIG. 2's Kit Creation Module 140 and Kit Buying Module 160 might be viewed as reflected in the Kit Creation 1142 and Kit Buying 1144 software resources of FIG. 11. And similarly, FIG. 2's Projects Repositories 110, Project Kits Repository 190, and Vendors Products Information Repositories 130 might be viewed as reflected in the Projects 1152, Project Kits 1154, and Vendor 1156 data resources shown in FIG. 11. Lastly, FIG. 2's Network 150 can be seen in the network interconnection shown in FIG. 11. Note also that modules 140 and 162 do not denote any specific packaging but are logically modules in the sense that the collective pieces of each function toward a common purpose, e.g., kit buying.

FIG. 2 is a high level block diagram illustrating the flow of information among the top level processing modules and repositories according to one embodiment. In this exemplary embodiment, the Kit Creation Module 140 enables a kit creator to select a Project 220 from a Projects Repository 110. A Project 220 may contain a description of materials and tools needed to implement it. A Kit Creation Module 140 facilitates creation of a Project Kit 250, including a detailed specification of project materials associating information about products from the Vendors Products Information Repositories 130 with each material. A created Project Kit 250 and its accompanying list/set of materials are stored in the Project Kits Repository 190. At some point in the future, the Kit Buying Module 160 retrieves one of the Project Kits 250 stored in the Project Kits Repository 190 per requests by one or more kit buyers. The Kit Buying Module 160 retrieves current products information from the Vendors Products Information Repositories 130 and presents a kit buyer with up-to-date products information, including product availability. The Kit Buying Module 160 enables a kit buyer to customize a Project Kit 250 based on pricing, products availability, taste or needs. Resulting Kit Orders 280 are dispatched to the Vendors 170 for fulfillment.

FIG. 3 is a flow chart illustrating operation of the kit creation module according to one embodiment. One of skill in the art would readily understand that any of these steps may occur in a different order than depicted in this illustrative example. In addition, other embodiments may include additional steps or substituted steps deviating from the steps presented, or omit steps altogether. A kit creator identifies a project 315 for which an associated project kit will be created by exercising user interface functionality of the kit creation module to supply an input which the kit creation module receives. Such user interface functionality generally may support audio prompts, screen displays, touch input, keyboard input, mice, trackballs, microphones, and the like. User interface devices may exist locally, such as a directly attached keyboard for example, or remotely, such as a network attached computer running a web browser for example. One of skill in the art appreciates that relevant user actions or activity described herein has technical correspondence to user interface facilities provided in an embodiment and substantive data processing responsive thereto, and should be viewed as such.

The project kit creation module facilitates creation of a list of project materials, indicating quantity of materials (number of items, units of measure) needed 320 as necessary. For each project material, kit creation module facilitates identification of a default product, substitute set of products or material specification 325 by the kit creator. For each project material, at least one suitable product, e.g., a default product, is identified and specified in the project kit. If a project must have or preferably has a certain relationship between or among different materials in the kit, then constraints and preferences are added 330. Based on the products specified, vendors and vendors product information are identified 335 and 340. The kit creator may preview the kit buying module and modify the project kit as needed or desired 345. The kit creator may add to the project kit project instructions 350. The completed project kit may be saved in the project kit repository 355 and a link may be created between the project and the project kit 360. Finally, the kit creation module may monitor and notify the kit creator when a default product or all substitute product options become unavailable 365. One of skill appreciates that the foregoing kit creation may include the active participation of a computer system user. In such a case, the kit creation module incorporates user interface (UI) elements and processing to present information to the user as a product of module operation and to receive information inputs from the user for module operation. One of skill further appreciates that the foregoing kit creation may reduce or eliminate the active participation of a computer system user. In such a case, the kit creation module may incorporate data scavenging, data mining, artificial intelligence, natural language processing, or other techniques to provide information processing that might otherwise be provided by a human user. For example, one embodiment of the kit creation module may automatically scan the webpages of arts and crafts websites, recognize pages containing lists of materials and instructional steps for a project, and extract a project name, list of project materials, and quantities needed from the webpage data to satisfy the processing associated with, for example, blocks 315 and 320 of FIG. 3 without user interaction. Accordingly, user interface facilities of a module may be supplanted by automation facilities entirely, partially, or optionally in an embodiment.

FIG. 4 is a flowchart illustrating the operation of the kit buying module according to one embodiment. One of skill in the art would readily understand that any of these steps may occur in a different order than depicted in this illustrative example. In addition, other embodiments may include additional steps or substituted steps deviating from the steps presented, or omit steps altogether. As stated previously, one of skill in the art further appreciates that relevant user actions or activity described herein has technical correspondence to user interface facilities provided in an embodiment and substantive data processing responsive thereto, and should be viewed as such.

A kit buying module facilitates a kit buyer's selection of a project kit associated with a project 410. The kit buying module may receive user input indicating the selection of a project kit via its user interface. Upon user selection, the kit buying module can retrieve project kit information (a project kit entry or instance) from a project kit repository. A kit buyer may find a link to a project kit embedded in a web site containing project information or a reference link to the project information. The system may retrieve information about the buyer and her preferences from her buyer profile 415 if she has been authenticated. Step 420 converts retrieved material specifications for the selected project kit into a substitute set of products. The system can extract manufacturer product IDs for each of the products from vendor product IDs 425. The system may collect current product information for each project material, for each potential product and vendor, so that the kit buyer can access information about the current product availability/unavailability and other attributes for each project material on the list—and do so automatically, without the need for manual inputs or intervention 430. For default material selections currently unavailable, the kit buying module may perform automatic substitution of unavailable products 435 taking into account products availability, constraints, as well as kit creator and buyer preferences, or other selection parameters to facilitate determination of an initial product selection for each project material. This step enables a kit buyer to place an order knowing whether each product purchased is currently in stock and will be shipped promptly. The kit buyer experience is thus a marked improvement from self-assembly of a project kit using a real or virtual shopping cart, adding one product at a time to the cart and not knowing until the end whether all products required for a project are readily available within the constraints of time, effort, and budget to shop. Accordingly, current product information is preferably queried in real-time or near real-time directly from the vendor or from another source known to refresh their data frequently. If the kit buyer already possesses any product on the list of project materials, the kit buyer may remove such materials from the list (deletions) or select optional materials 440 to enhance the project (additions). The kit buyer may be presented with a fully configured currently available project kit 445 that is ready to order. The system may enable the kit buyer to customize the project kit based on any number of criteria, e.g., total materials price, choice of vendors, deliver options and product selection preferences 450. Step 455 references customization of project kit by the buyer. A kit buyer may perform customization of material selection relying on a set of substitute products or a material specification created by the kit creator. (A more detailed illustration of a kit buyer customization based on the material specification is presented in FIGS. 6 and 7.) The kit buying module may allow the kit buyer to optimize project kit based on selected criteria 460, e.g. total price or fastest delivery time. The system can then create a complete purchasing order and facilitate purchasing with one or more vendors 465. A complete purchasing order is a representation of all the products needed to be purchased at each source vendor to fully satisfy the instant materials list recorded in computer storage. Purchasing may be facilitated by displaying or printing a purchase order for each vendor, for example, or by connecting to vendor servers over the Internet and initiating or completing an online purchase using information from the complete purchasing order, as another example. The kit buying module may calculate and distribute commission fees among contributors to the creation of the project kit 470 based on the information contained in the project kits. If the purchase order reflects different products from the original project kit, then the purchase order can be converted into a project kit variant and saved in a project kit repository 475. This enables kit buyers either to order one of the existing kit variants or use one of them as a starting point for customization. As the kit buyer works on the project, the system can enable the buyer to provide helpful comments and ratings, upload an image of the completed project or modify instructions for the project kit variant. 480.

Access to the information in vendor's product databases (such as may be useful in the processing represented by FIGS. 3 and 4, just described, for example) is accomplished by various means and from various sources in the practice of inventive aspects. In one embodiment, access to a vendor's product information is implemented via a published API. In another embodiment, a copy of the database is made locally available on a regular basis and the system queries this database copy. In yet another embodiment the system extracts information based on the analysis of information returned from http requests. Vendor's product information may be sourced from different places. In one embodiment, a vendor serves as the source of product information. In another embodiment, product specification information is obtained from a product manufacturer. In yet another embodiment information is provided by a 3rd party information aggregator. Third party information aggregator may serve various roles such as a product distributor, an affiliate program manager, an internet product search company, a broker, an auction site administrator or an information reseller. In one embodiment all product information comes from a single source. In another embodiment various pieces of information such as product specification, inventory information, shipping information, promotions and discounts are obtained from various sources.

FIG. 5 illustrates a relation between the information stored with vendor products and manufactured products according to one embodiment. Manufactured Product 510 displays product properties that are intrinsic to this particular product as manufactured by a given manufacturer. Vendor product 520 displays product information for the Manufactured Product 510 that is specific to the vendor such as Price, Shipping, etc. Embodiments may contain the capability for establishing a correspondence between manufacturer product IDs, vendor product IDs and universal product IDs.

FIG. 6 illustrates construction of a material specification utilizing assisted products exploration according to one embodiment. The kit creator enters descriptive information for the Material 1 603 along with identification of the Material Type 607. Products for this material are found at three vendors 610. Materials of this type are described by two properties Property1 630 and Property2 640 with corresponding property values shown. Kit creator identified that products with Property2 640 value of Option24 are not suitable for this material for the purposes of this project. This would trigger removal of Product1-3 660 since it had Property2 value of Option24. Block 650 represents the status of the material specification process. A kit creator may also identify that products with Property1 630 values of Option12 and Option14 are suitable for this material for the purposes of this project. Product3-1 670 is the default product specified by the kit creator. Product3-2 680 was removed by the kit creator as unsuitable. Arrow 685 indicates that there are more products available from Vendor3.

FIG. 7 illustrates a customization by a buyer utilizing assisted products exploration and state of processing of material selection according to one embodiment. In this example, a kit buyer de-selected Vendor 2 from the list of vendors 610. Because of the de-selection of Vendor 2, all corresponding products available from this vendor have been removed 755.

The system verifies that all imposed constraints are not violated. The system de-selects products that are incompatible with current selections. When a default product for a material has been removed due to unavailability or incompatibility, the system may pick a substitute product or allow kit buyer to make an alternative selection.

A kit buyer restricted the price range for this material 620, triggering removal of Product1-1 755. The kit buyer decided that products that have Property1 630 value of Option14 will not work to the buyer's taste. This triggered a removal of Product1-2 735 since it had Property1 value of Option14. The kit buyer decided that products that have Property2 640 value of Option21 would not satisfy the buyer's needs. This triggered a removal of Product2-3 745 since it had Property2 value of Option21. Product3-1 670 is the default product specified by the kit creator, but it was removed because it was not available for purchase when the kit buyer was in the process of customizing the project kit. Product3-3 is a product selected by the kit buyer as the current choice for the Material 1.

FIG. 8 illustrates a simple operation for a kit creation with a simple wiki support allowing multiple kit creators to contribute to the creation of a project kit according to one embodiment. In one embodiment, a project kit creator 120a may find an image or a photograph on the Internet and create a project with a project kit 805 on a website posting picture 810 along with a request for help with implementation of the project for an artifact similar to the one depicted in the image. After discovering the Project Kit 805, Project Kit Creator 120b may post Project Instructions 840. Project Kit Creator 120c contributes by filling in project meta information 820, Project Comments 830, and creating a list of consumable project materials with product defaults selected 850. Project Kit Creator 120e contributes by providing information for Project Tools 860 and Tool Supplies 870. Project Kit Creator 120d provides additional instructions information in the form of a Picture1 844 for the Step1 of the instructions, adding a Video2 848 for the Step2 and commenting on the StepN 846. Project Kit Creator 120d makes project materials customizable by providing a materials specification for Materials 850, while Project Kit Creator 120f fills in materials specifications for Tools 860 and Supplies 870, while commenting on one of the ToolX 865.

FIG. 9 illustrates a more complex operation for a kit creation with wiki support allowing multiple kit creators to contribute to creation and modification of multiple project kit variants according to one embodiment. In this example, Project Kit Creator 120z creates a Project Kit 250 for the Project 220. Project Kit Creator 120y may modify original Project Kit 250, creating a Project Kit Variant 250a, while Project Kit Creator 120v creates a Project Kit Variant 250b and Project Kit Creator 120x creates a Project Kit Variant 250c. In one embodiment, such project kit variants may be selecting different substitute products or may have completely altered one or more materials from what was specified in the Project Kit 250. Project Kit Creators 120w and 120s used Project Kit Variant 250a as a starting point and collaboratively created a Project Kit Variant 250d. Project Kit Creators 120u and 120t collaborated on creating Project Kit Variant 250e borrowing pieces from the Project Kit Variant 250b and 250c.

FIG. 10 illustrates a customization by a kit buyer. FIG. 10 illustrates GUI elements implemented by the kit buying module to interact with the kit buyer, allowing the customization. GUI elements include checkbox group 610, slider control 1020, and graphics windows 650, 1030, 1060, and 1070. FIG. 10 also illustrates processing elements of the kit buying module including user interface selections processing 1011, constraint processing 1012, and global consistency maintenance processing 1013, and data elements of the kit buying module including stored constraints 1040 and 1041. Block 610 represents a user input indicating de-selection of Vendor 2 resulting in the presentation of X-out graphical element 712. UI Selections Processing block 1011 further responds to the de-selection action by updating the status of each product from Vendor 2 and is visually presenting that to the user by adding strikeout bar graphical elements 766a, 766b, 1036, 1066, and 1076 to the graphics windows associated with Material1 650, Material2 1030, Material3 1060, and Material4 1070, as shown. Block 1020 represents user input indicating the imposition of restrictions on the total price of the kit resulting in the placement shown for slide indicator graphic elements 1021 and 1022. UI Selections Processing block 1011 further responds to the price restriction action by updating the status of a product now falling outside of the designated price range and visually presenting that to the user by adding X-out graphic element 1031 to graphics window 1030. Block 1040 represents a stored Constraint1 indicating that size of Material3 must be larger than size of Material1. Material3 graphics window 1060 illustrates a product selected by constraint processing 1012 shown as a check in a box 1061 as a substitute for a default product. Material1 graphics window 650 illustrates a product in the left bottom corner that was removed by constraint processing 1012 via application of the Constraint1 1040 and the Material3 selection. Material4 graphics window 1070 illustrates removal (shown as X-out graphical element 1071) of default product in the top left corner via application of Constraint2 1041 by constraint processing 1012 and selection of a product shown as checkbox graphical element 1032 in Material2 graphics window 1030.

In one implementation, the kit buying module utilizes constraint propagation process to mark as “not available” for selection a product satisfying the project material specification presented to a buyer that is incompatible with currently selected products or all still available options for other project materials. Material3 1060 illustrates removal of two products (shown as X-out graphical elements 1062 and 1063) via operation of a global consistency maintenance process 1013.

FIG. 11 depicts illustrative computer systems useful in the practice of inventive subject matter. One of skill in the art will appreciate that computer system 1100 of FIG. 11 is a complex computer system that includes and specifically depicts a further number of computer systems of lesser and lesser complexity, any one or number of which, or various combinations thereof, or alternatives, may be useful in embodiments practicing the inventive subject matter described herein. Computer system 1100 includes systems 1104, 1182, 1184, and 1186, each connected to network 1162. Computer system 1104 is further shown to include system 1102 coupled to system 1176 by a network connection. Computer system 1102 is further shown to include computer system 1110, and systems 1172 and 1174, each coupled to network 1160 which also is depicted as an attachment point for the aforementioned network connection between computer systems 1102 and 1176. Computer system 1110 includes computer core 1120, storage 1130, and human interface 1128, and network interface 1129 (shown coupled to network 1160). Computer core 1120 includes processor 1122, memory (storage) 1124, and I/O 1126 shown coupled together by communications bus. Storage 1130 is shown to include stored software resources 1140 and stored data resources 1150. Stored software resources 1140 includes kit creation software 1142, kit buying software 1144, operating system 1146, and other software 1148. Stored data resources 1150 includes projects data 1152, project kits data 1154, vendor data 1156, and other data 1158. The computer system 1110 is comparable to a typical PC, workstation, server card, smartphone, tablet computer, or the like, with software and data in storage. Systems 1172, 1174, and 1182 of system 1100 may each be of comparable configuration to computer system 1110. Computer system 1102 is what may be considered to be a LAN-scale computer system, here, for illustration, showing three workstation-scale computer systems 1110, 1172, and 1174, interconnected by network 1160. Computer system 1104 is what may be considered to be a WAN-scale computer system, here, for illustration, showing two LAN-scale computer systems, 1110 and 1176, interconnected by a network. Computer system 1100 is what may be considered to be an Internet-scale computer system, here for illustration, showing workstation-scale computer system 1182, LAN-scale computer system 1186, and WAN-scale computer systems 1104 and 1184, interconnected by network 1162 such as the Internet.

In one embodiment, processor 1122 includes one or more microprocessor circuits to fetch and execute instructions, each possibly having a number of CPU cores. Processor 1122 is coupled by a signaling bus to memory/storage 1124 and I/O 1126. In one embodiment, memory/storage 1124 is a primary type of storage including high-speed RAM devices to hold instructions and data for processing. Memory/storage 1124 can, of course, include many and various types of storage devices for holding computer readable data (including program instructions). I/O 1126 includes circuitry for interfacing input and output devices with processor 1122, directly or via memory 1124. I/O 1126 is coupled to storage 1130 and to human interface 1128. Human (User) interface 1128 includes one or more devices for presenting information to a user of the system and for receiving input from the user. In one embodiment user interface 1128 includes a color graphics display screen, a keyboard, and a pointer device such as a mouse. Such an embodiment is thus equipped to present user interface display elements and receive related user input signals as previously illustrated, discussed, and suggested (as in relation to FIGS. 1, 7, 8, and 10, for example). Storage 1130 includes one or more devices and any associated recording media used to store and access computer readable software and data. In one embodiment, storage 1130 is persistent secondary storage provided by one or more hard disk drives, optical disk drives, flash devices, solid state storage units, tape drives, and associated media whether removable or not. In one embodiment, storage 1130 includes multiple items of removable media, for example, multiple DVD-ROMs.

Storage 1130 as shown in FIG. 11 includes stored software resources 1140. Illustrative kit creation block 1142 includes program instructions for project kit creation functions as earlier described. Illustrative kit buying block 1144 includes program instructions for project kit buying functions as earlier described. Illustrative OS block 1146 includes program instructions for an operating system as may provide an execution environment in conjunction with a computer core such as 1120. Storage 1130 as shown in FIG. 11 further includes stored data resources 1150. Illustrative projects block 1152 represents projects data such as depicted and described earlier, for example, in relation to projects repositories 110 of FIG. 2. Illustrative project kits block 1154 of FIG. 11 represents project kit data such as depicted and described earlier, for example, in relation to project kits repository 190 of FIG. 2. Illustrative vendor block 1156 of FIG. 11 represents vendor related data such as depicted and described earlier, for example, in relation to vendors products information repositories 130 of FIG. 2.

Notably, the software 1140 and data 1150 resources shown together in storage 1130 are illustrative, and one of skill readily appreciates that the various software and data resources needed for an embodiment may be variously combined, distributed, stored, and conveyed among the various components of a particular implementing computer system. One of skill also readily appreciates that while embodiments are readily considered as implementations where stored program instructions (software) are executed by a processor or CPU, a computer core like 1120 of FIG. 11, for example, may be implemented as a hardwired ASIC in another embodiment, or as a programmed FPGA in another embodiment. These and other alternatives are possible.

### SOME EXAMPLE EMBODIMENTS

One of skill in the art appreciates novel subject matter illuminated by the foregoing discussion. It is further appreciated that many varied embodiments are possible that make use of one or more aspects of the novel subject matter. Some of the many possible embodiments include but are not limited to:

In one embodiment, the system does not require for a kit to be pre-configured. As an example, the system can provide a kit buying capability without prior kit creation by another human participant. When a buyer visits a website page with a project description the computer system allows a buyer to create a kit for the project on the fly by:

Automatically extracting a list of materials and tools from the project description.

Automatically extracting amounts of each materials needed.

Automatically extracting project yield in terms of finished items produced.

Allowing buyer to modify the number of finished items to be produced.

For each material and tool,

Automatically performing search of vendor's inventory of products based on the material/tool information extracted from the project description.

Identifying best match products for the extracted material and tool description.

Extracting product availability information

Selecting optimal size packaging for the products to closely match required amount.

Selecting best matching product based on the material description, amount needed and expressed buyer preferences. Buyer preferences may include preferred vendors, time of delivery, pricing preferences, delivery methods, delivery price limits, product quality preferences, product reviews ratings, product features (properties), etc.

Also selecting alternative products.

Optimizing overall kit based on project description and buyer preferences.

Presenting a buyer with a complete order with an ability to customize.

Such functionality may be delivered via a custom browser extension or via a software application.

In another embodiment the system automatically creates a kit variant based on the comments posted on the project page by analyzing materials/tools and product substitutions, alterations of amounts and quantities, etc.

In one embodiment, the system has access to the inventory of stores of brick and mortar vendor. A buyer may request help in locating selected kit materials and tools in a store instead of completing the transaction on-line. The system identifies location of each product by identifying isle and location of the product in the isle.

Applications to food recipes, as a specific example:

In one embodiment, the system is applied to the domain of food recipes. As an example, a buyer installs a browser plugin for the Kit buying service. When a buyer visits a web page containing a recipe (project), she is presented with an option to purchase a kit with all the ingredients (and utensils) needed to implement the recipe.

In one embodiment as applied to the food recipes, the system enables a buyer to automatically adjust(modify) recipe and the kit based on user food preferences, e.g. organic only, gluten free, low sodium, nuts allergy, sugar free, etc. The system would perform certain product substitutions based on the constructed database of similarly tasting food items.

In one embodiment, as applied to the food recipes, the system enables a buyer to modify a recipe by requesting a food substitution. The system would automatically propose other component substitutions taking into account certain established food pairings. For example, when a buyer requests to substitute chicken for lamb, the system may recommend to use mint as an ingredient.

Further enumerated examples include but are not limited to:

### Example 1

An electronic commerce system having a computer-readable storage medium having computer-executable code, the computer-executable code comprising:

a kit creation module for:

identifying a project;

creating from the project a project kit comprising a list of project materials;

associating with each project material on the list at least one of: a default product, a substitute set of products, or a material specification;

storing the project kit in a project kit repository;

a kit buying module for:

selecting a project kit from the project kit repository;

collecting current product information from at least one vendor for each project material listed in the selected project kit;

using said current product information to select a product for a listed project material; and

creating a complete purchasing order for the selected product.

### Example 2

The system of Example 1, wherein said product is available from any vendor.

### Example 3

The system of Example 1 wherein said product is available from a restricted set of vendors.

### Example 4

The system of Example 1 wherein a vendor is a broker or product information aggregator.

### Example 5

The system of Example 1 further comprising code for extracting product information from product information APIs or from a website of a vendor.

### Example 6

The system of Example 1 further comprising a profile comprising a preference for one or more of the following: product types, product brands, pricing, vendors, vendor stores, product ratings, vendor ratings, shipping costs, and delivery methods.

### Example 7

The system of Example 1 further comprising information stored in a profile and selection of products and creation of a material specifications using said information.

### Example 8

The system of Example 1 wherein the selection of products is based on selection of vendors stored in a profile.

### Example 9

The system of Example 1 further comprising a guided question answering module for creating a substitute set of products for a material, creating a material specification for the material, and selecting a product for the material.

### Example 10

The system of Example 1 further comprising code for extracting a manufacturer product identification number from a vendor's product information.

### Example 11

The system of Example 1 wherein a vendor product identification number is associated with a corresponding manufacturer product identification number for a product on the list of materials.

### Example 12

The system of Example 1 comprising code for assisted products exploration and similar products search for a project material via multiple selections and multiple de-selections of a product, a material property, or a material property value, or range restricting a material property value.

### Example 13

The system of Example 12, wherein the system is capable of using the code for assisted products exploration and similar products search to enable creation of material specification and selection of a product.

### Example 14

The system of Example 1 wherein the material specification further comprises at least one of textual keywords, material type, and restrictions of a material property values.

### Example 15

The system of Example 1 further comprising code for converting said material specification into a substitute set of products.

### Example 16

The system of Example 1 further comprising code for ordering a substitute set of products for a material.

### Example 17

The system of Example 1 wherein a person utilizing the kit creation module is not directly associated with a vendor.

### Example 18

The system of Example 1 wherein a project material is associated with a quantity of the project material needed.

### Example 19

The system of Example 1 wherein a project material is consumable or non-consumable.

### Example 20

The system of Example 1 wherein a project material is required or optional.

### Example 21

The system of Example 1 further comprising a constraint on at least one project material, material property, or project kit property.

### Example 22

The system of Example 1 further comprising a preference for at least one project material, a product property, or a project kit property.

### Example 23

The system of Example 1 further comprising code that automatically generates a constraint or a preference for at least one of a project material, a product property, or a project kit property.

### Example 24

The system of Example 1 wherein creating a material specification further comprises optimizing generation of commission fees.

### Example 25

The system of Example 1 wherein the kit creation module is capable of associating images, textual instructions, comments, videos, audios and keywords, with the project.

### Example 26

The system of Example 1 wherein the system is capable of interpreting a project description to create at least one of a project material, a default product, a substitute set of products, a material specification, a constraint or a preference.

### Example 27

The system of Example 1 which is capable of creating a notice if a product for a project material becomes unavailable.

### Example 28

The system of Example 27, which is capable of generating a recommendation for a set of substitute products from which to choose.

### Example 29

The system of Example 1 further comprising code enabling entry of project instructions.

### Example 30

The system of Example 1 wherein the system is capable of making said project kit available for selection.

### Example 31

The system of Example 30, wherein the system is capable of making said project kit available for selection utilizing an API of an aggregation website containing references to the project.

### Example 32

The system of Example 1 further comprising code enabling multiple kit creators to collaborate on creating a kit.

### Example 33

The system of Example 1 further comprising code for creating a project kit variant for a project.

### Example 34

The system of Example 33, wherein the creating of a project kit variant is achieved by altering a project kit variant, merging multiple project kit variants, or converting a complete purchasing order into a kit variant.

### Example 35

The system of Example 34, further comprising code for version control to maintain dependencies and propagate changes between kit variants.

### Example 36

The system of Example 1 wherein the selecting of products further comprises accessing a selection made by one or more previous kit buyers.

### Example 37

The system of Example 1 wherein the kit buying module is capable of facilitating a purchase of at least two of the same project kit and taking into account the consumable and non-consumable property of each material in calculating a needed quantity of each material on the list.

### Example 38

The system of Example 37, further comprising capability to specify the number of project implementers able to share non-consumable material.

### Example 39

The system of Example 1 wherein current product information comprises current availability, pricing, shipping, taxation, or promotions.

### Example 40

The system of Example 1 wherein the kit buying module is capable of imposing a constraint on all of the project materials on the list for one or more of the following: material properties, pricing, vendors, vendor stores, product ratings, vendor ratings or delivery methods.

### Example 41

The system of Example 1 further comprising a buyer profile comprising information of the following: vendor login, membership in vendor affinity programs, materials already in possession, shipping, or payment procedures.

### Example 42

The system of Examples 21, and/or 22, wherein the selecting of products further comprises satisfying constraints and preferences.

### Example 43

The system of Example 42, wherein the selecting of products further comprises optimizing product selections based on vendor preferences, total price, delivery options, or commission fees.

### Example 44

The system of Example 1 wherein the system is capable of enabling a kit buyer to select a product from an applicable set of substitute products, wherein the product satisfies the constraints associated with the corresponding material.

### Example 45

The system of Example 1 further comprising a constraint propagation process that marks as not available for selection a product that satisfies a project material specification but is incompatible with one or more currently selected products or all available options for other project materials

### Example 46

The system of Example 1 which is capable of automatically creating a material specification if there are no currently available products for a material.

### Example 47

The system of Example 1 which is capable of automatically relaxing a material specification if there are no currently available products satisfying a product material specification.

### Example 48

The system of Example 1 which is capable of generating suggestions for relaxing a constraint if there are no currently available products for a material.

### Example 49

The system of Example 1 which is capable of calculating commission fees and distributing said commission fees among a set of contributors to the information contained in the project kit.

### Example 50

The system of Example 1 wherein the selecting of a product further comprises simultaneously satisfying more than one project material.

Further variety yet in inventive embodiments will be apparent to one of skill in consideration of the following:

A system provides capability of manually or automatically configuring optimized kits for orders containing more than one kit, allowing for more cost-effective purchase of certain materials. The system provides automated optimization recommendations offering more cost-effective multi-kit purchases. For example, when ordering 20 kits, order a roll of fabric with scissors instead of 20 individual pieces of fabric; or when ordering 6 kits containing a 1G paint, order one 5G paint bucket and one 1G bucket.

An embodiment may facilitate item substitutions of the form: 2 of item X for 4 of item Y.

Allow to configure several kit variants. One of the variants may automatically be selected for a kit buyer based on certain preferences. For example, a kit creator may configure a kit variant using child-friendly materials only and when a kit buyer browses for kits for children, child friendly kits will be pre-selected.

Provide mechanisms to automatically calculate quantities of materials to order based on customizable project dimensions. For example, a user may enter dimensions of a floor and % expected waste and the system would automatically compute the number of boxes of tiles needed. (In some cases, different dimensions may also influence product selections as well, e.g. lumber length.)

Allow selection of a color scheme for the completed product. Provide interface with on-line color scheme repositories—e.g., integrate ability for a customer to pick a color palette from www.ColorLovers.com or www.kuler.Adobe.com, and limit selection of kit product colors to the selected palette.

Drive ordering based on the visual selection/configuration of the product by making visual frames or 2-D or 3-D models of the configured products. For example:

a. Visual Jewelry design. Select type of jewelry—necklace, ring, earring, etc. Select shape. Select size. Allow to pick beads, stones, mounts, material type, clasps, etc. and show immediate quick graphic preview of the look.

b. Pattern design—Provide simple preselect than move/drag type interactive interface to customize a design, with preview in actual colors/materials. If larger than 8×11, offer an option of printing and sending it via Kinko's or similar service.

Provide capability to place orders in sections over time based on project phases.

Provide a way to create customizable fonts for inclusion in kit design.

For complex DIY projects facilitate ordering samples of materials, e.g. tile, floor, paint, etc.

Provide an ability to subscribe and be notified about newly created kits by a certain author, or in certain category, or with certain tags.

Allow references to the hierarchically nested kits with appropriate quantity references. This would be of particular value in application to recipe kits.

Allow to automatically create 3-D models from a photo of the object to facilitate visual selection process and provide 3D visualizations.

Connect 3D models from a photo capability to 3D printing facility.

Allow to mark a material as a vintage piece that may need to be procured at a specialty store or a second hand store. Flag kits with vintage items.

One of skill in the art appreciates that these and many other embodiments using inventive subject matter disclosed herein are possible. One further understands that details presented in preceding embodiments are for purposes of instruction and illustration and are not intended to limit the scope of the inventive subject matter which is set forth, at least in part, in the claims that follow.

1. A method in an electronic data processing system to facilitate the online purchase of all project kit materials by a user, such as an artisan, craftsperson, hobbyist, or the like, from one or more vendors, the method comprising:
receiving a first user input indicating a selection of a project kit;
retrieving project kit information based on said first user input wherein said project kit information comprises a set of one or more project materials;
automatically collecting current product information from at least one vendor for each project material of said set wherein said current product information comprises price and availability;
determining a product selection for each project material of said set using said current product information; and
recording in computer storage a complete purchasing order based on said determining, the complete purchasing order comprising information identifying a first source vendor and a corresponding first source vendor product.

2. The method of claim 1 further comprising initiating an online purchase by transmitting information to the first source vendor including first source vendor product information.

3. The method of claim 1 wherein said determining a product selection comprises preferring for selection a second potential product over a first potential product where the current product information regarding the first potential product indicates unavailability.

4. The method of claim 3 wherein said determining a product selection comprises receiving second user input indicating an addition or deletion of a project material of said set, and modifying said set in computer storage in response to said input.

5. The method of claim 4 further comprising initiating an online purchase by transmitting information to the first source vendor including first source vendor product information.

6. The method of claim 1 wherein said determining a product selection includes determining a product selection for a product material of said set using information regarding a user preference stored in a user profile.

7. The method of claim 1 wherein said determining a product selection includes determining a product selection for a product material of said set using information regarding a constraint for one or more of material property, pricing, vendor, vendor store, product rating, vendor rating, and delivery method.

8. A computer system to facilitate the online purchase of all project kit materials by a user such as an artisan, craftsperson, hobbyist, or the like, from one or more vendors, comprising:
one or more processors,
one or more memories, each coupled to at least one of said processors, and collectively comprising stored instructions that when executed by said one or more processors cause the performance of a method comprising:
receiving a first user input indicating a selection of a project kit;
retrieving project kit information based on said first user input wherein said project kit information comprises a set of one or more project materials;
automatically collecting current product information from at least one vendor for each project material of said set wherein said current product information comprises price and availability;
determining a product selection for each project material of said set using said current product information; and
recording in computer storage a complete purchasing order based on said determining, the complete purchasing order comprising information identifying a first source vendor and a corresponding first source vendor product.

9. The system of claim 8 wherein said method further comprises initiating an online purchase by transmitting information to the first source vendor including first source vendor product information.

10. The system of claim 8 wherein said determining a product selection comprises preferring for selection a second potential product over a first potential product where the current product information regarding the first potential product indicates unavailability.

11. The system of claim 10 wherein said determining a product selection comprises receiving second user input indicating an addition or deletion of a project material of said set, and modifying said set in computer storage in response to said input.

12. The system of claim 11 wherein said method further comprises initiating an online purchase by transmitting information to the first source vendor including first source vendor product information.

13. The system of claim 8 wherein said determining a product selection includes determining a product selection for a product material of said set using information regarding a user preference stored in a user profile.

14. The system of claim 8 wherein said determining a product selection includes determining a product selection for a product material of said set using information regarding a constraint for one or more of material property, pricing, vendor, vendor store, product rating, vendor rating, and delivery method.

15. A computer readable medium having program instructions for facilitating the online purchase of all project kit materials from one or more vendors, wherein execution of the program instructions by one or more processors of a computer system causes the one or more processors to carry out a method comprising:
receiving a first user input indicating a selection of a project kit;
retrieving project kit information based on said first user input wherein said project kit information comprises a set of one or more project materials;
automatically collecting current product information from at least one vendor for each project material of said set wherein said current product information comprises price and availability;
determining a product selection for each project material of said set using said current product information; and
recording in computer storage a complete purchasing order based on said determining, the complete purchasing order comprising information identifying a first source vendor and a corresponding first source vendor product.

16. The computer readable medium of claim 15 wherein said method further comprises initiating an online purchase by transmitting information to the first source vendor including first source vendor product information.

17. The computer readable medium of claim 15 wherein said determining a product selection comprises preferring for selection a second potential product over a first potential product where the current product information regarding the first potential product indicates unavailability.

18. The computer readable medium of claim 17 wherein said determining a product selection comprises receiving second user input indicating an addition or deletion of a project material of said set, and modifying said set in computer storage in response to said input.

19. The computer readable medium of claim 18 wherein said method further comprises initiating an online purchase by transmitting information to the first source vendor including first source vendor product information.

20. The computer readable medium of claim 15 wherein said determining a product selection includes determining a product selection for a product material of said set using information regarding a user preference stored in a user profile.

21. The computer readable medium of claim 15 wherein said determining a product selection includes determining a product selection for a product material of said set using information regarding a constraint for one or more of material property, pricing, vendor, vendor store, product rating, vendor rating, and delivery method.

22. A method in an electronic data processing system to facilitate the online purchase of all project kit materials by an artisan, craftsperson, hobbyist, or the like from one or more vendors, the method comprising:
receiving first user input indicating a selection of a project kit;
retrieving project kit information based on said first user input wherein said project kit information comprises a set of one or more project materials;
automatically collecting current product information from at least one vendor for each project material of said set wherein said current product information comprises price, availability, shipping, and taxation;
receiving second user input indicating an addition or deletion of a project material of said set, and modifying said set in computer storage in response to said input producing a modified set of one or more project materials;
receiving third user input indicating an election to save the modified set and in response thereto creating a project kit variant instance in computer storage based on said modified set;
determining a product selection for each product material of said modified set using said current product information, information regarding a user preference stored in a user profile, and information regarding a constraint for one or more of material property, pricing, vendor, vendor store, product rating, vendor rating, and delivery method;
recording in computer storage a complete purchasing order based on said determining, the complete purchasing order comprising information identifying for each project material in said modified set a source vendor and a source vendor product; and
initiating an online purchase by transmitting information to each source vendor identified in said complete purchasing order including source vendor product information related to said source vendor and payment information.

23. A method in an electronic data processing system to facilitate the online creation of a project kit for later purchase online by a user, such as an artisan, a craftsperson, hobbyist, or a teacher, from a plurality of vendors, the method comprising:
receiving input identifying a project material;
allowing an independent user to optionally supply first input comprising default product information for said project material including a default product vendor;
allowing said independent user to optionally supply second input comprising alternate product information for said project material including an alternate product vendor;
allowing said independent user to optionally supply third input comprising material specification product information for said project material including one or more material properties;
retrieving current default product information from said default product vendor including price via a network-based interface in response to receiving said first input;
retrieving current alternate product information including price from said alternate product vendor via a network-based interface in response to receiving said second input;
retrieving current ad hoc product information including price from an ad hoc vendor via a network-based interface using said material properties to select said ad hoc product in response to receiving said third input;
presenting a product information display to the independent user using retrieved of said current product information, current alternate product information, and current ad hoc product information;
allowing said independent user to supply product selection input in response to said product information display; and
recording information in a project kit instance in computer storage in response to said product selection input.
